(19) United States
(12) Patent Application Publication
(10) Pub. No.: US 2003/0089248 A1
(43) Pub. Date: May 15, 2003

(54) Method and device for moisturatization of a paper board web in calendering

(76) Inventors: Pekka Linnonmaa, Jarvenpaa (FI); Antti Heikkinen, Helsinki (FI); Markku Kyytsonen, Numminen (FI); Ville Vuorijarvi, Lohja (FI); Pekka Moisio, Helsinki (FI)

Correspondence Address: LATHROP & CLARK LLP, 740 REGENT STREET SUITE 400, P.O. BOX 1507, MADISON, WI, 537011507

(21) Appl. No.: 10/182,368

(22) PCT Filed: Jan. 26, 2001
(86) PCT No.: PCT/FI01/00072

(30) Foreign Application Priority Data
Jan. 28, 2000 (FI) 20000187
Sep. 15, 2000 (FI) 20002036
Oct. 13, 2000 (FI) 20002267

(51) Int. Cl. B30B 3/04

(52) U.S. Cl. 100/161

(57) ABSTRACT

The invention relates to a method for calendering a paper or board web, in which method the web (W) is calendered in at least one calendering nip (N1-N8), and in which method the web (W) is moisturized before calendering. In the method, the web (W) is moisturized by means of moisturization (20; 21) very close before at least one calendering nip (N1, N5). The invention also relates to a calender for calendering a paper or board web comprising at least one calendering nip (N1-N8) and at least one device for moisturizing the web (W). The device for moisturizing the web (W) is a moisturizing device (20; 21) and that the moisturizing device (20; 21) is placed very close before or in at least one calendering nip (N1, N5).

The invention relates to a method according to the preamble of claim 1.

The invention also relates to a calender according to the preamble of claim 13.

When calendering advantageously in a paper machine it is useful to raise the moisture content of the surface layer of paper so as to be as high as possible and to keep the middle layers of paper optimally dry. By this means, in a nip/nips of a calender or in another contact under pressure there occurs a permanent deformation in the moist surfaces of paper and the dry middle part recovers like an elastic material when the compression load ends. Such a state of the web leads to the fact that the caliper of paper is better preserved when the same surface quality is sought to be achieved (compared with a situation in which moisture is uniformly distributed in paper).

The surface of paper is affected during calendering by external compressing pressure, temperature, and the moisture contained in the web. The smoothening of the paper surface in a calender nip is based on a quick pulse generated by heat and pressure on the surface of paper: the polymers of paper exceed their glass transition temperature because of raised temperature and moisture, and soften so as to be mouldable. By the action of pressure, the surface of a hot and smooth steel roll is copied to the softened and deformable fibres. At the outlet of the nip, the temperature of the fibres falls below the glass transition temperature of polymers, the fibres cool and solidify in their smoothed structure. In addition thereto, the properties of the web are reduced because of compression when the caliper of the web is reduced.

Through calendering, attempts are made to improve the quality values of paper that have already been achieved or, at a standard quality level, to achieve a higher speed or a better bulk of the paper. It is known that the plasticity of paper, i.e. its readiness of being moulded, can be increased by raising the temperature and/or the moisture content of the paper. A considerable change takes place in the plasticity of paper when the temperature of the polymers contained in the paper rises to or beyond the so-called glass transition temperature. Then, the paper can be moulded more readily than below the glass transition temperature. An increase in the moisture content of paper lowers the glass transition temperature. Most commonly, the paper web is heated in a calender nip by means of a heatable roll, a so-called thermo roll and, in addition to this, possibly by means of steam treatment before the calender. The steam treatment also increases the moisture content of the paper, thereby lowering the glass transition temperature and thus enhancing the mouldability of paper.

Thus, when paper is calendered, the effect of calendering on the paper is highly dependent on the moisture content and temperature of the fibres contained in the paper at the time of calendering: the mouldability of the fibres is increased sharply even as if by a jump when their temperature reaches the so-called glass transition temperature, which is directly proportional to the moisture content of the fibres, or when their temperature is above the glass transition temperature. Above the glass transition temperature, it is easy to produce permanent deformations in the fibres, and below said temperature the deformations tend to be reversible. In order to ensure the permanence of the effects of calendering, the web must be moisturized to lower the glass transition temperature and, in addition, very high calendering temperatures and high pressures must be used, in which connection the entire web readily exceeds the glass transition temperature and, thus, the deformation takes place evenly through the entire cross section of the web in the cross direction.

With respect to the prior art relating to the invention, reference is also made to FI Patent 98 230 (corresponding U.S. Pat. No. 5,524,532), which discloses a method and a device of calendering a paper or board web, wherein the; web is passed through a calendering nip. The calendering nip is formed of a heated roll and another roll or of a heated roll and an extended-nip roll or of a heated roll and a belt arrangement, by means of which the web is pressed against the heated roll, wherein, before the web enters the calendering nip, a moisture distribution is produced between the surfaces of the web in the thickness direction of the web such that the moisture is higher on that side of the surface of the web which is to be calendered than in the web interior A temperature difference is produced between the surfaces of, the web such that the web surface to be calendered will be on the side of a lower temperature, and evaporation of moisture from the web is prevented during the moisture transfer process when the moisture present in the web is transferred towards the surface on the side of the lower temperature.

It is also known from the prior art that by controlling the imbition time water can be caused to stay in the very surface layers of paper. With respect to the prior art relating to this, reference is made to the publication A. Heikkinen, P. Linnonmaa & M. Diebel “Practical Aspects Concerning Moisture Gradient Calendering”, Wochenblatt für Papierfabrikation, Jahrgang 127, 1999, Nr. 10, pp. 680-685. It is essential that the moisturizing device has a sufficiently small droplet size in order that the small water amounts which are applied shall form a film and not drops here and there on the surface of paper. The droplet size shall typically be less than 200 μm, less than 20 m on average, advantageously 10 to 20 μm.

The essential gradient control variables include:

Moisturizing delay

Water temperature

Water quantity

Number of applications

Even though this description mainly refers to paper, it shall be understood that the disclosure also relates to the calendering of board.

One multinip calendering method known in the state of the art is supercalendering, which is calendering in a calender unit in which nips are formed between a smooth-surface press roll, such as a metal roll, and a roll coated with a resilient cover, such as a polymer roll. The resilient-surface roll conforms to the surface contours of paper and presses the, opposed side of paper evenly against the smooth-surface press roll. Today the supercalender typically comprises 10 to 12 nips and for the purpose of treating both sides of the web, the supercalender comprises a so-called reversing nip, in which there are two resilient-surface rolls against each other. The linear load increases in the calender from the top nip to the bottom nip because of the force of gravity.

The problems in calendering today are mainly due to the following factors.

a. Initial moisture content, the number of steam treatments and the temperature of calendering are mainly determined by the final moisture content after calendering such that

i. when the final moisture content becomes too low, the web absorbs moisture, which results in deterioration of the achieved gloss in the form of afterroughening, and

ii. when the final moisture content becomes too high, the drying of the web effectively destroys the quality values that have been attained.

b. On the other hand, the determination of the initial moisture content of calendering is affected by desired optical properties and the level of blackening. When the final moisture content becomes too high, the opacity, i.e. translucence of the web deteriorates, which appears in a finished paper product as an increase in print-through values, and the blackening level rises, which reduces the selling value of paper in the form of diminished brightness and a poor visual impression.

Because of these factors, the real control variables of a modem calender are relatively limited and the operating window of an individual calender has become rather narrow with the increasing drying capacity of the calender. Today the improvement of quality is thus successfully accomplished in practice only by increasing the number of nips in the calender. In connection with this, the controllability problem is aggravated by the fact that with the increasing number of nips, the difficulties in setting the initial moisture content and temperature of the web also increase such as to avoid curl of the web and that the web is still sufficiently moist in the lowermost nips of the calender and thus mouldable, which is of high significance especially with regard to achieving smoothness and also density.

As known in the state of the art, one problem in connection with calenders has been constituted by the high temperatures of thermo rolls because they dry the fibrous web too much.

Calenders known in the state of the art are also modernized so as to meet the requirements of today's technology.

An aim of the invention is to create a method for optimizing paper quality.

An aim of the invention is to create a new method in calendering of a paper and a board web.

An aim of the invention is also to improve calendering of the web and to improve control of the moisture gradient of the web.

A further aim of the invention is to create a method and a device which are suitable for use in connection-with modernization of multinip calendering, in particular in connection with supercalenders.

A further aim of the invention is to create a new method in multinip, soft or long-nip calendering of a paper and board web.

With a view to achieving the objectives stated above as well as those coming out later, the method according to the invention is mainly characterized in that which is set forth in the characterizing part of claim 1.

The calender according to the invention is in turn mainly characterized in what is set forth in the characterizing part of claim 13.

The invention relates to the optimization of moisturizing to maximize the surface quality of paper.

When measuring different surface and bulk properties of paper, an optimum moisturizing method has been formed in different quality optimization cases.

In the method for optimizing the quality of paper according to the invention, the web is moisturized, in which connection a liquid, a water emulsion, a liquid mixture or a dispersion is applied at a predetermined location to a paper web or to the surface of the like moving past said location, and the web is passed after that to surface treatment. The liquid is applied at such an early stage that the fibres in the paper web or the like subjected to moisturizing have time to absorb liquid in a sufficient amount of liquid which is required before surface treatment.

The surface treatment contact with the web to be surface-treated and the effect of contact under pressure (e.g. nip effect in a calender) transfer the moisture that has not been absorbed into fibres, fibre walls and/or fibre bonds into them. The moisturizing agent must be in fibres, in fibre walls and/or in fibre bonds, advantageously in fibres.

Advantageously, the moisturizing agent is applied immediately before a nip and/or in a nip and/or during a nip effect and/or between nip effects.

The advantageous applications of the invention, the method in calendering and the calender are based on the use of liquid, water emulsion, liquid mixture, dispersion, water sprays or equivalent moisturizing devices, by means of which the moisture content of the web is raised most preferably such that the moisture content of the web (after the moisturizing device before the set of rolls) when it enters the calender is at a level of 4 to 15%, most preferably 8 to 12%. In the arrangements known in the state of the art, the initial moisture content before the calender has typically been of the order of 2 to 7% (before the set of rolls) In accordance with this embodiment of the invention, moisturizing devices are placed, depending on the calender type and the desired application, very close before the first calendering nip and, about the middle of the nips before a nip in which a thermo roll or equivalent has been placed on one side of the web, for example, close to a reversing nip or before each calendering nip or before desired calendering nips. The location of the moisturizing device is adjusted such that-the imbition time after moisturization at a desired running speed before the nip is 0 to 1 s.

In this description, by the ambition time is meant the time during which the moisturization has time to be effective before the effect of calendering in the nip and, in this connection, the imbition time ends when the contact of the surfaces compressed in the calendering nip ends, i.e. the compression pressure ceases to act during the nip effect.

In accordance with the invention, the imbition time of the moisturizing agent is also advantageously controlled, in which connection the middle of the web remains dry and partly recovers after calendering. The web surfaces to be calendered are in turn very plastic because of high moisture content, and deform readily. The middle portion has been brought into a desired moisture content before the moisturization process, which is one of the control parameters of the moisturization gradient used in connection with the invention.

In one advantageous application of the invention in which the method is applied in a multiroll calender in which the set of rolls is formed of an upper set of rolls and of a lower set of rolls, moisturizing devices are placed very close to the first nip and close to a reversing nip. The paper web in the upper set of rolls has a total moisture content of about 4 to 15%, most preferably 5 to 7%, in which connection the permanent compression of the web remains slighter than in arrangements known in the state of the art, in which the moisture content of paper in the upper set of rolls is of the order of 8 to 12%, most preferably 8 to 10%. The first side of the web is calendered in the upper set of rolls and the surface layer is deformed readily while its moisture content is high, typically 20-to 40%. Close to the reversing nip, the other side of the web not yet calendered is subjected to moisturization with water and its surface moisture content is typically 15 to 40% and, after that, the other side of the web is calendered. The suitable final total moisture content of, for example, paper is 4 to 8%;

In accordance with one application of the invention, moisturizing devices are placed asymmetrically such that the distance of the device moisturizing the web side which is calendered second from the first thermo roll nip of the lower set of rolls is equal to the distance of the device moisturizing the web side which is calendered first from the first calendering nip.

The calendering method according to the invention is also applied advantageously such that several moisturizing units are placed inside a set of rolls, which units are, for example, of the type of so-called air-atomizing units or, most advantageously, steam-atomizing units. In connection with the invention it is advantageous to use steam treatment before or after moisturization. In particular, in connection with air-atomizing units it is advantageous to use steam treatment, for which steam boxes are placed most advantageously before a nip after a water moisturizing device.

In accordance with one advantageous further feature of the invention, in addition to moisturizations inside a set of rolls, it is possible to use moisturizers placed outside the set of rolls.

By using moisturization inside the set of rolls in accordance with the invention, considerably higher temperatures can be applied in the calender than those used in the calenders known in the the state of the art. This is advantageous because, for example, when the calendering temperature is raised to a level of 200 to 300° C., a 10-roll calender can be replaced with a 6-roll one. In that connection, it is also often possible to leave out the steam boxes used in state-of-the-art applications, whereby considerable cost savings are achieved. Higher temperatures can be used in connection with the invention for the reason that moisturization allows the moisture content of paper to be regulated, whereas conventional steam moisturization does not function when the temperature of paper rises close to 100° C.

One application of the new and inventive method of multinip calendering and the multinip calender according to the invention is based on the use of moisturizing sprays or equivalent moisturizing devices, by means of which the moistures content of the web is raised in the calender most appropriately such that the moisture content of the web entering the calender is at a level of 1 to 10% and the moisture content of the web coming out of the calender is 4 to 7%. In the arrangements known in the state of the art, the initial moisture content before the calender has been typically of the order of 2 to 4%. In accordance with the invention, moisturizing devices are placed, depending on the type of multinip calender and on the desired application, at least very close before the second calendering nip and after a reversing nip before the calendering nip situated after it. The distance of the moisturizing device is adjusted such that the imbition time after moisturization is 0 to 1 s.

In accordance with an advantageous embodiment of the invention, moisturization inside the, calender is used when a multinip calender, most advantageously a supercalender, is modernized, in which connection the already existing 12-roll supercalender can be preserved, and no new deflection-compensated rolls are needed. When modernizing a supercalender, water moisturizing devices are placed very close before the second nip and after the reversing nip before the nip situated after it. The drying and possible overdrying of the web are compensated for by this means. The surface temperature of the thenrmo roll placed after the liquid moisturizing device as well as that of the roll situated after it can be, 100 to 350° C., advantageously 150 to 250° C. The thermo rolls after the reversing nip can also be kept at a temperature of 100 to 350° C., advantageously 150 to 250° C. In this way, in the modernization arrangement according to the invention it is possible to use very high temperatures of thermo rolls because the drying of the web in calendering is compensated for by inside moisturizing. When using the arrangement according to the invention, the loading principle of the 12-roll supercalender can be kept unchanged, thereby achieving savings of costs. A supercalender according to an advantageous application of the invention comprises at least two, most advantageously four hot thermo rolls and at least two liquid moisturizing devices as well as four, most preferably six polymer covered rolls.

In accordance with one advantageous further feature of the invention, moisturization/steam treatment is/are used for profiling in the cross direction. By means of the profiling it is possible to affect the properties of the web in the cross direction.

The invention is suitable for use both in on-line and in off-line calendering. Above, the invention has mainly been described in connection with on-line calendering. In off-line calendering, the basic principles of the method and the calender according to the invention correspond to those described above, but 4 to 0.6% is most advantageously used as the ingoing moisture content of paper before moisturization, and moisturization can be accomplished either one-sidedly or two-sidedly.

The invention is particularly suitable for use in connection with multiroll calenders but also in connection with other types of calenders, among other things, soft or extended-nip calenders. Depending on the calender application, the moisturizer is placed, for example, before each nip or before desired nips or before the first nip and close to or in a reversing nip.

The invention is particularly suitable for use in connection with multinip calenders, in particular supercalenders.

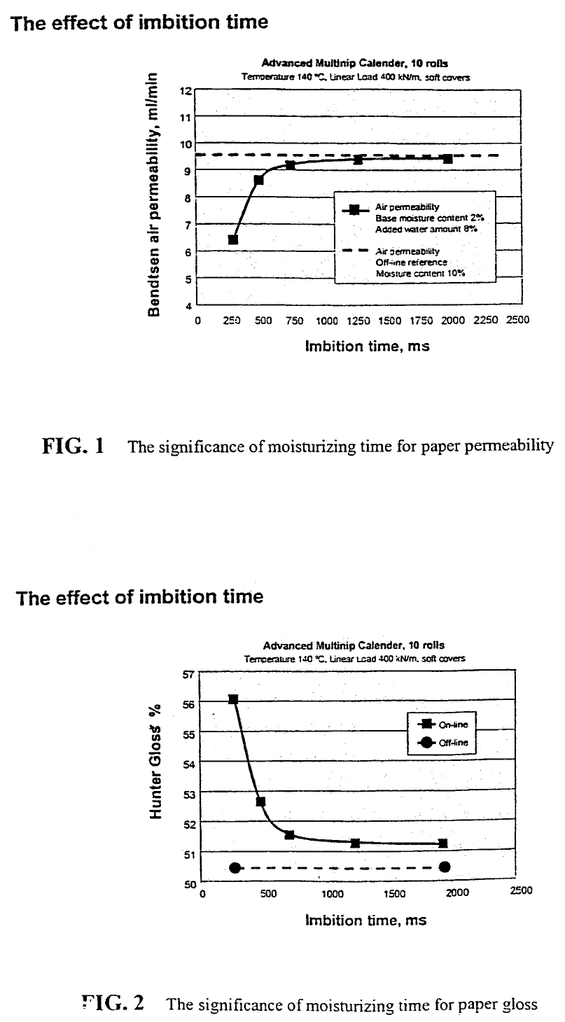

In the following, the invention will be described in more detail with reference to the FIGS. 1 to 9 in the accompanying drawing, to the details of which the invention is, however, not by any means intended to be narrowly confined.

The invention and the general benefits attainable by the invention, when the surface properties of paper have been optimized in accordance with the invention, have been illustrated by means of the accompanying FIGS. 1 to 7, in which

FIG. 1 illustrates the significance of moisturizing time for paper permeability in a multinip calender comprising 10 rolls. The calendering, temperature is 140° C. and the linear load is 400 kN/m.

FIG. 2 illustrates the significance of moisturizing time for the gloss of paper. The calender and the calendering conditions are the same as those described in connection with FIG. 1.

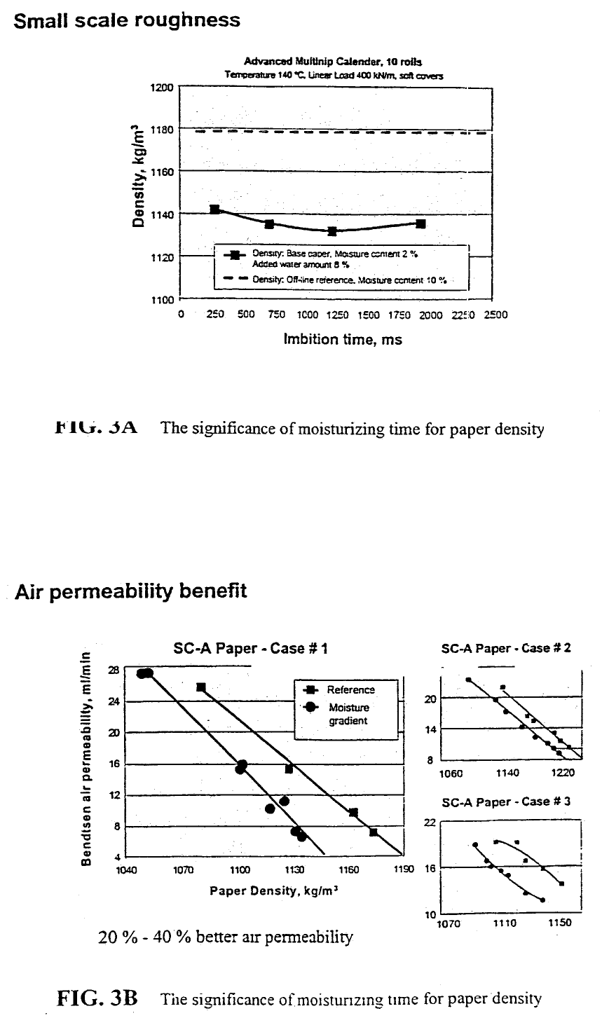

FIGS. 3A and 3B illustrate the significance of moisturizing time for paper density such that FIG. 3A shows a correlation between moisturizing time and density and FIG. 3B shows three different cases (case #1, case #2 and case #3) of the relationship of density to air permeability. The calender and the conditions are the same as in FIGS. 1 and 2.

FIG. 4 illustrates how the strength properties are formed and preserved better when using the method according to the invention. The figure shows the relationship between tensile strength and linear load. The linear load is the average of 25 samples.

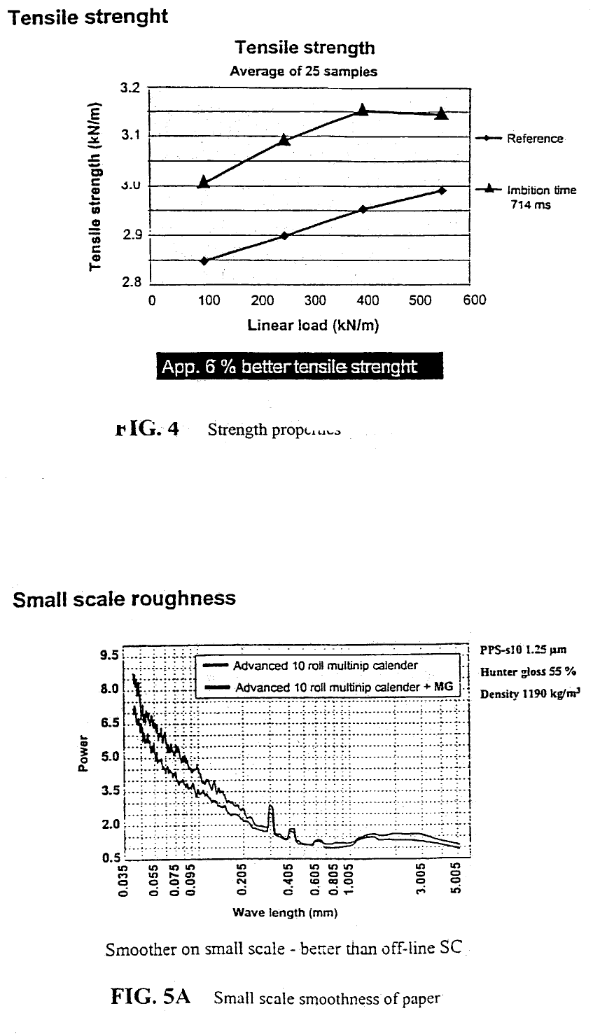

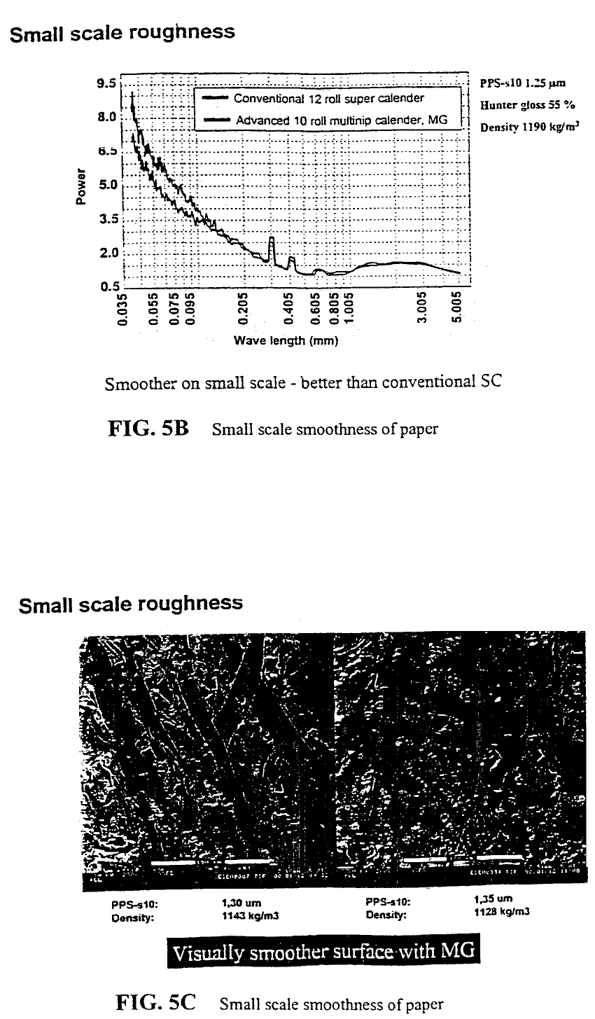

FIGS. 5A and 5B show how paper is smoother on a small scale, which leads to better printability and, for example, to lower consumption of printing ink. FIGS. 5A and 5B show how the invention provides an improvement over different types of known calenders and calendering methods.

FIG. 5C shows how small-scale smoothness in the method according to the invention is better than previously. The surface of paper is molten, i.e. smooth, that is, when using the invention, the paper is visually smoother.

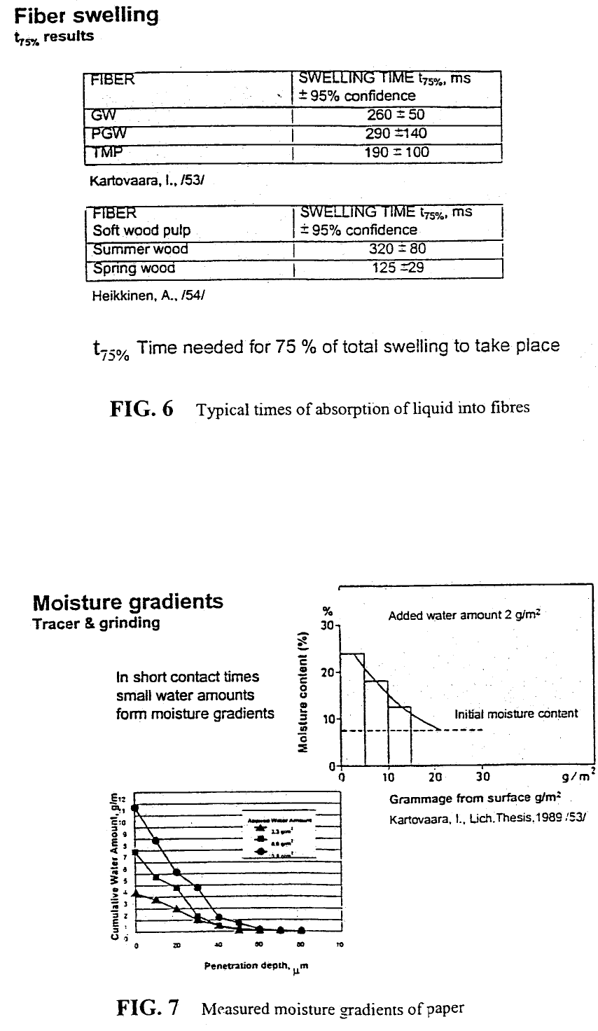

The table of FIG. 6 shows typical times of absorption of liquid into fibres.

FIG. 7 shows measured moisture gradients of paper. Small water amounts with short contact times form a moisture gradient.

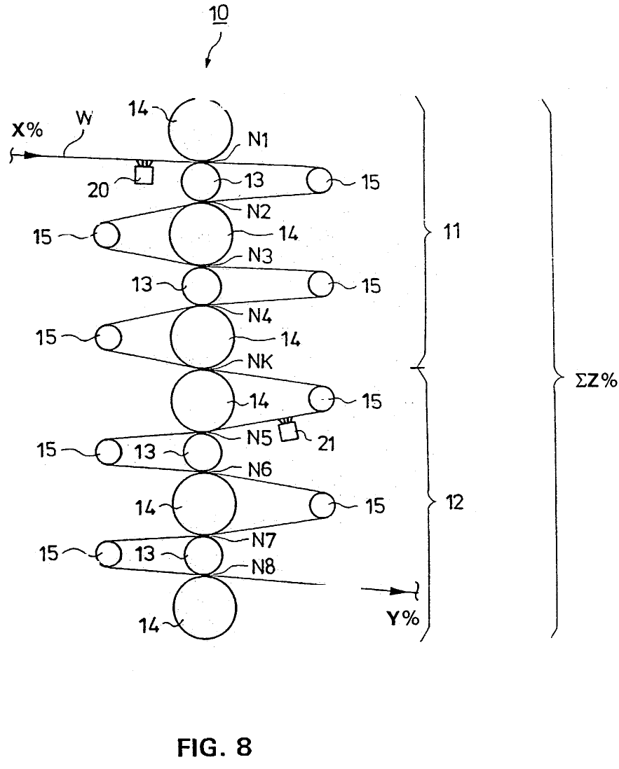

FIG. 8 schematically shows an application of the invention in connection with a multiroll calender.

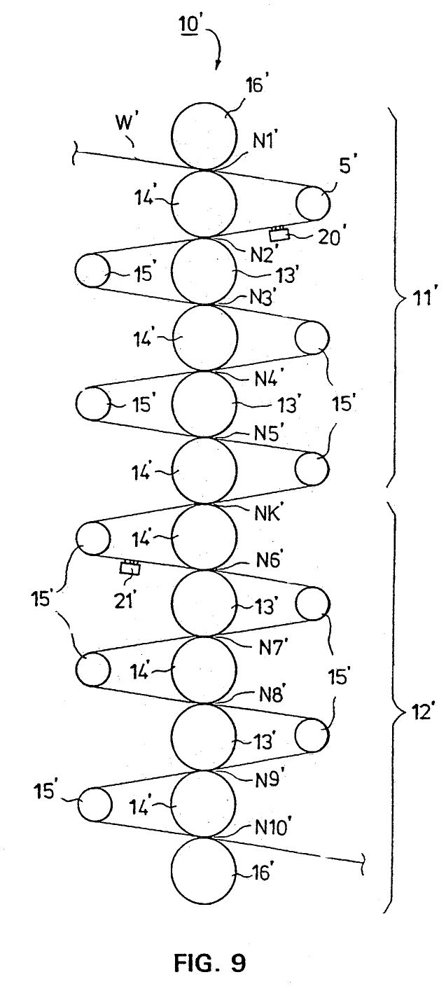

FIG. 9 schematically shows an application of the invention in connection with a supercalender.

In accordance with FIG. 8, the multiroll calender is composed of a set of rolls 10 in which several calendering nips N1, N2-N8 have been formed one upon the other, wherein the set of rolls 10 of the multiroll calender is formed of an upper set of rolls 11 and of a lower set of rolls 12, which are formed of smooth-surface press rolls 13, such as metal rolls, of rolls 14 coated with a resilient cover, such as paper or polymer rolls, placed alternately one other the other, and of reversing or guide members 15 guiding the run of the web W to be calendered. The successive nips N1, N2-N8 of the multiroll calender are thus always formed between a rigid-shell roll 13 and a resilient-shell roll 14. Between the upper set of rolls 11 and the lower set of rolls 12 there is a reversing nip NK, in connection with which the side of the web W to be calendered is changed. In accordance with an advantageous application of the invention, a moisturizing device 20, 21 is placed before the first calendering nip and close to the reversing nip NK. The top and bottom rolls in the set of rolls 10 are deflection-compensated polymer rolls.

The run of the fibrous web W which is calendered is as follows. The web W is run via the moisturization 20 into the topmost first nip N1 of the upper set of rolls 11 in the multiroll calender, from which nip the web W is run around a turning member 15, for example a turning roll into the next lower nip N2. After that, the web W meanders around turning members 15 and runs through the next nip N3 and, after that, the web W is run through the lowermost nip N4 of the upper set of rolls 11. After that, the web W side to be calendered is changed in the reversing nip NK, and the web W is passed via the moisturizing device 21 placed close to the reversing nip NK into the first nip N5 of the lower set of rolls 12, from which nip the web W is run again around a turning member 15 into the next lower nip N6. The invention also encompasses applications in which the web is run through the so-called reversing nip while the nip is open, in which connection the web is not compressed in the nip. Again, the web W meanders around turning members 15 and runs through the next nip N7 and finally the web W is run through the lowermost nip N8 of the lower set of rolls 12. After the bottom nip N8 of the lower set of rolls 12, the web W is run to the process stage which follows after calendering.

Thus, in the application of the invention shown in this FIG. 8, the web W side to be calendered first is moisturized with the moisturizing device 20 before the first nip N1 and the other side of the web W is moisturized close to the reversing nip NK with the moisturizing device 21. The location of the moisturizing device 20 with respect to the first nip N1 is adjusted such that the imbition time after moisturization is 0 to 1 s, most preferably 100 to 400 ms, and the, distance of the moisturizing device 21 from the reversing nip NK is adjusted such that the imbition time after moisturization is 0 to 1 s, most preferably 100 to 400 ms.

As shown in FIG. 9, the supercalender is composed of a set of rolls 10′ in which several calendering nips N1′, N2′-N8′ have been formed one upon the other, wherein the set of rolls 10′ of the multiroll calender is formed of an upper set of rolls 11′ and of a lower set of rolls 12′, which are formed of heatable, smooth-surface press rolls, i.e. thermo rolls 13′, such as metal rolls, of rolls 14′ coated with a resilient cover, such as paper or polymer rolls, placed alternately one other the other, and of reversing or guide members 15′ guiding the run of the web W′ to be calendered, as well as of deflection-compensated rolls 16′ of the set of rolls 10′, which rolls 16′ are situated as the top and bottom rolls of the set of rolls 10′. The successive nips N2′-N9′ of the multiroll calender are thus formed between a thermo roll 13′ and a resilient-surface roll 14′. Between the upper set of rolls 11′ and the lower set of rolls 12′ there is a reversing nip NK′ formed between two resilient-surface rolls 14′, in connection with which nip the side of the web W′ to be calendered is changed. In accordance with this application of the invention, a water moisturizing device 20′,21′ is placed very close before the second calendering nip N2′ and after the reversing nip NK′, before the first nip N6′ of the lower set of rolls 12′.

The run of the fibrous web W′ which is calendered is as follows. The web W′ is run into the topmost first nip N1′ of the upper set of rolls 11′ of the calender, in which nip the temperature of the deflection-compensated roll 16′ is about 60° C., from which nip N1′ the web W is run around a turning member 15′, for example a turning roll via the moisturization 20′ into the next lower, i.e. second nip N2′. After that, the web. W meanders around turning members 15′ and runs through the next nips N3′, N4′ and, after that, the web W′ is run through the lowermost nip N5′ of the upper set of rolls 11′ The temperature of the thermo rolls 13′ in the upper set of rolls 11′ is 100 to 350° C., advantageously 150 to 250° C. and that of the deflection-compensated roll 16′ about 60° C. After that, the web W1 side to be calendered is changed in the reversing nip NK′, and the web W′ is passed after the reversing nip NK′ via the moisturizing device 21′ placed before the first nip N6′ of the lower set of rolls 12′ into the first nip N6′ of the lower set of rolls 12′, from; which nip the web W′ is run again around a turning member 15′ into the next lower nip N7′. Again, the web WI meanders around turning members 15′ and runs through the next nips N8′, N9′ and finally the web W′ is run through the lower-most nip N10′ of the lower set: of rolls 12′. The temperature of the thermo rolls 13′ in the lower set of rolls 12′ is 100 to 350° C., advantageously 150 to 250° C. and the temperature of the deflection-compensated steel roll 16′ is about 60° C. After the bottom nip N8′ of the lower set of rolls 12′, the web W′ is run to the process stage which follows after calendering.

Thus, in the application of the invention shown in this FIG. 9, the web W′ side to be calendered first is moisturized with the moisturizing device 20′ before the second nip N2′ and the other side of the web W′ is moisturized after the reversing nip NK′ with the moisturizing device 21′. The distance of the moisturizing device 20′ from the nip N2′ is adjusted such that the imibition time after moisturization is 0 to 1 s, most preferably 100 to 400 ms, and the distance of the moisturizing device 21′ from the nip N6′ is adjusted such that the imbition time after moisturization is 0 to 1 s, most preferably 100 to 400 ms.

In determining the location of the moisturizing device, the point of the nip is considered to be that point in the nip in which the contact of compressing surfaces ends, i.e. the compression pressure ceases to act during the nip effect.

The amount of moisturization used in connection with the invention

ΣZ=Z_{top surface}+Z_{bottom surface},

where Z_{top surface} and Z_{bottom surface} are surface moisturization values. The moisturization amount is divided for the upper set of rolls and for the lower set of rolls based on desired smoothness, gloss, curl and porosity and, when needed,

regulation of unequal sidedness Z_{top surface}/Z_{bottom surface} (advantageously 0.8 to 1.2)

is carried out.

A typical final moisturization target

Y%=(X%+ΣZ%)−amount of evaporation (typically 3.5 to 6.5%)

amount of evaporation=f (T, roil diameter, roll material, load, speed, web run) (typically to 6%)

X %=moisture content of paper when it enters the calender.

The reference signs indicating the computational process are shown in FIG. 8.

Above, the invention has been described with reference to one of its advantageous embodiments only, to the details of which the invention is not by any means intended to be narrowly confined.

1. A method for calendering a paper or board web in a multinip calender, in which method the web (W, W′) is calendered in calendering nips (N1-N5; N1′-N10′), and in which method the web (W, W′) is moisturized before calendering, characterized in that, in the method, the web (W, W′) is moisturized by means of moisturization (20;21;20′,21′) very close before and/or in, at least one calendering nip (N1,N5; N2′,N6′) after a reversing nip (NK,NK′) such that the imbition time after moisturization at a desired naming speed before the nip is 0 to 1 s, and that the moisturization (20;21;20′,21′) is earned out as moisturization inside a set of rolls (10;10′) of the calender.

2. A method according to claim 1, characterized in that, in the method, moisturization is carried out such that a desired shape of moisture gradient is achieved in each specific case.

3. A method according to claim 1 or 2, characterized in that, in the method, the moisture content of the web (W,W′) coming out of the calender is brought by means of moisturization to a target moisture level Y %=(X %+ΣZ %)—evaporation occurring during calendering, where X % is the moisture content of paper when it enters the calender and ΣZ % is the amount of moisturization used.

4. A method according to claim 1 or 2, characterized in that, in the method, the moisturization is carried out in at least one stage such that the difference between the amount of drying taking place in the calender and the base moisture content of the web is compensated for by moisture additions.

5. A method according to any one of claims 1 to 4, characterized in that, in the method, the web (W) is moisturized before the first calendering nip (N1) of the calender.

6. A method according to any one of claims 1 to 5, characterized in that, in the method, the web M is moisturized before each calendering nip.

7. A method according to any one of claims 1 to 6, characterized in that, in the method, the imbition time of a moisturizing agent is controlled and/or regulated such that the moisture stays in surface layers of the web (W,W′).

8. A method according to claim 1, characterized in that, in the method, the web (W′) is moisturized by means of liquid moisturization (20′,21′) at least very close before the second calendering nip (N2′) of the upper set of rolls (W) and after a reversing nip (NK′) before the first nip (N6′) of the lower set of rolls.

9. A method according to claim 1 or 8, characterized in that, in the method, the web (W) is moisturized before more than two calendering nips.

10. Ar method according to any one of claims 1 or 8 to 9, characterized in that, in the method, at least some of the heatable rolls of the calender are heated to a temperature of 100 to 350° C., advantageously 150 to 250° C.

11. A method according to any one of claims 1 to 10, characterized in that, in the method, moisturization and/or steam treatment is/are used for profiling in the cross direction.

12. A multinip calender for calendering a paper or board web comprising calendering nips (N1-N8; N1′-N10′) and at least one device for moisturizing the web (W′), characterized in that the device for moisturizing the web (W′) is a moisturizing device (20;21;20′,21′) and that the moisturizing device (20;21;20′, 21′) is placed very close before and/or in, at least one calendering nip (N1;N5;N2′, N6′) after a reversing nip (NK, NK′) such that the imbition time after moisturization at a desired running speed before the nip is 0 to 1 s, and that the moisturizing device (20,21;20′,21′) is placed so as to be a device inside the set of rolls (10;10′) of the calender.

13. A calender according to claim 12, characterized in that the location of the moisturizing device (20, 21;20′,21′) with respect to the calendering nip (N1; N5), in particular with respect to the outlet side of its effective calendering nip is adjusted such that the imbition time after moisturization is 0 to 1 s.

14. A calender according to claim 12 or 13, characterized in that the moisturizing device (20,21;20′,21′) is a liquid spray.

15. A calender according to any one of claims 12 to 14, characterized in that a moisturizing device (20,21) is placed before the first nip (N1) of the calender and close to a reversing nip (NK) of the calender.

16. A calender according to any one of claims 12 to 14, characterized in that a moisturizing device is placed before each nip of the calender.

17. A calender according to any one of claims 12 to 16, characterized in that the moisturizing device (20,21;20′,21′) is an air-atomizing device.

18. A calender according to any one of claims 12 to 16, characterized in that the moisturizing device (20,21;20′,21′) is a steam-atomizing device.

19. A calender according to claim 17, characterized in that a separate steam box is placed in connection with the moisturizing device.

20. A calender according to claim 14, characterized in that the moisturizing devices are placed asymmetrically such that the distances of the devices from the nips situated after them are equal.

21. A calender according to any one of claims 12 to 20, characterized in that the calender further comprises moisturizers placed outside the calender.

22. A calender according to claim 12, characterized in that the device for moisturizing the web (W) is a liquid moisturizing device (20′;21′), and that the liquid moisturizing device (20′; 21′) is placed very close before at least the second calendering nip (N2′) of the upper set of rolls (11′) and the first calendering nip (N6′) of the lower set of rolls (12′).

23. A calender according to any claim 22, characterized in that a liquid moisturizing device is placed before several nips of the calender.

24. A calendar according to any one of the preceding claims 12 to 22, characterized in that the moisturizing device allows profiling in the cross direction.
